(19) United States
(12) Patent Application Publication
(10) Pub. No.: US 2005/0228173 A1
(43) Pub. Date: Oct. 13, 2005

(54) Material having crosslinking structure and method for forming the same

(75) Inventors: Juin-Yih Lai, Yangmei Township (TW); Ying-Ling Liu, Fongyuan City (TW); Yu Huei Su, Tainan City (TW)

Correspondence Address: ROSENBERG, KLEIN & LEE, 3458 ELLICOTT CENTER DRIVE-SUITE 101, ELLICOTT CITY, MD, 21043, US

(73) Assignee: Chung Yuan Christian University, Chung-Li City (TW)

(21) Appl. No.: 10/822,609

(22) Filed: Apr. 12, 2004

(51) Int. Cl. C08B 37/00

(52) U.S. Cl. 536/53; 264/109

(57) ABSTRACT

The present invention discloses a material having cross-linking structures. This material comprises a modified substrate containing polysaccharide and a plurality of bridges formed on the modified substrate. Moreover, the bridges bond to the polysaccharide and are self-bonded, so as to form the cross-linking structures, wherein the bridges are formed by a cross-linking agent. Furthermore, this invention also discloses a method for forming a membrane having cross-linking structures, wherein the method comprises a dissolution process, a mixing process and a membrane fabricating process.

### BACKGROUND OF THE INVENTION

1. Field of the Invention

This present invention relates to a modified material and method for forming the same, and more particularly, to a material having cross-linking structure and method for forming the same.

2. Description of the Prior Art

Polysaccharides are naturally occurring polymers (biopolymers) of carbohydrates, the most abundant of which are cellulose and starch. Carbohydrates are synthesized by plants through photosynthesis reactions that use solar energy to convert carbon dioxide and water into glucose (or other simple sugars) and oxygen. Many of these carbohydrate molecules are then linked together to form polymers such as starch for energy storage or cellulose to support the plant. Polysaccharides are classified on the basis of their main monosaccharide components and the sequences and linkages between them, as well as the anomeric configuration of linkages, the ring size (furanose or pyranose), the absolute configuration (D- or L-) and any other substituents present. Certain structural characteristics such as chain conformation and intermolecular associations will influence the physicochemical properties of polysaccharides. These polymers are primarily used as our food energy sources and construction materials. Because of their abilities to alter the basic properties of water, i.e., thickening and gelling, polysaccharides have been used in many industrial sectors including food, textile, paper, adhesive, paint, pharmaceuticals, and cosmetics, among which the food, textile, and paper industries are the largest consumers. In these applications the polysaccharides are used to perform such functions as emulsification, stabilization, encapsulation, flocculation, film formation, binding, and coating.

Pervaporation is a membrane separation process that can be employed to separate liquid mixtures. It can be used to separate liquid mixtures with azeotrope. In addition, it comprises advantages such as easy operation, energy saving, and others. Therefore, pervaporation attracts much attention in industry. The key to the development of pervaporation is the preparation of membranes with excellent separation performance. The separation stems from the difference in the penetration rates of each component in the feed crossing the membrane, and the permeation rate is determined by each component's solubility and diffusivity in the membrane. The diffusivity is related to the size of the molecule permeating through the membrane and the solubility is related to the affinity between the permeating molecules and the membrane. Thus, one strategy to improve the pervaporation performance is to adjust the affinity between the membrane and the preferred components. For example, synthesizing a material with special hydrophilic properties or modifying commercial materials to raise the hydrophilicity is usually used. Another application is to control the membrane structure to adjust the permeating components' diffusivity in the membrane. Because of its high hydrophilicity and good membrane-forming property, chitosan is a good material for pervaporation.

Another membrane separation process similar to pervaporation is vapor permeation. The vapor permeation process first vaporizes the organic liquid feed, and then brings the membrane in contact with the vapor feed. The major difference between these two processes is the state of their feeds. Pervaporation is with liquid feed and vapor permeation is with vapor feed. Generally, vapor permeation is more suitable for separation feeds containing dissolved solids or feeds with impurities. Vapor permeation is also appropriate to be attached to a distillation column for continuously separating the vapor distillate.

There are three important indexes for separation performance of pervaporation and vapor permeation [symbol] selectivity [symbol] α [symbol] , flux and PSI [symbol] pervaporation separation index [symbol] . In a binary system comprising component i and component j, the selectivity is defined as [symbol] Yᵢ/Yⱼ [symbol] / [symbol] Xᵢ/Xⱼ [symbol] , wherein Xᵢ and Xⱼ are the weight percentages in the feed, and Yᵢ and Yⱼ are the weight percentages in the permeate; i denotes the preferred component. The flux is defined as W/ [symbol] A×t [symbol] , wherein W is the mass of the permeate, A is the membrane area that allows the feed component to permeate, and t is the operation time. In addition, the PSI [symbol] pervaporation separation index [symbol] is defined as the product of the selectivity and the flux. Higher value of PSI indicates better separation performance. Generally speaking, PSI is a convenient index for evaluation of the membrane performance in pervaporation and vapor permeation.

Polysaccharide membrane can be prepared by a dry process, in which the polysaccharide/water solution is evaporated to remove water and to form dense membranes. However, such membranes cannot be directly used in the pervaporation process because the polysaccharide membrane will re-dissolve when contacting with aqueous solution, this is caused by the swelling of the membrane. Thus, a cross-linking process is usually required. For example, a paper named “Pervaporation with chitosan/hydroxyethylcellulose (CS/HEC) blended membranes” of A. Chanachai et. al., published on J. Membr. Sci. 166(2000) 271-280, described that a composite membrane was used for separating organic solution containing 90 wt % of Iso-propyl alcohol [symbol] IPA [symbol] at 60 □. The composite membrane shows flux being 175 g/m² per hour and water selectivity being 26091; another paper named “Cross-linked chitosan composite membrane for the pervaporation dehydration of alcohol mixtures and enhancement of structural stability of chitosan/polysulfone composite membranes” of Robert Y. M. Huang et. al., published on J. Membr. Sci. 160(1999) 17-30, described that a composite membrane was used for separating organic solution containing 70 wt % of Iso-propyl alcohol [symbol] IPA [symbol] at 50 □. The composite membrane shows flux being 1000 g/m² per hour and water selectivity being 800. According to the foregoing, after the polysaccharide membrane is cross-linked, the stability and selectivity are improved, but the permeation flux is low, which limits the application of polysaccharide membranes in pervaporation. A reasonable explanation is provided that the common cross-linking agents usually have small size, which resulted short distance between polymer chains of polysaccharide, and then the flux of membrane is quite low.

Therefore, new polysaccharide membranes that possess high selectivity, high flux, and high stability for the pervaporation process are still required.

### SUMMARY OF THE INVENTION

In accordance with the present invention, a new material having cross-linking structure is provided. This material can meet the requirement of high selectivity, high flux, and high stability for the separation process.

It is one of the objects of this invention to fabricate a polysaccharide membrane having cross-linking structure. Cross-linking agent with suitable molecular structure is selected to adjust the distance between polymer chains in the membrane, so as to form a separation membrane with high selectivity and high flux. Furthermore, part structure of the cross-linking agent may be inorganic. Therefore, another object of this invention is to uniformed disperse inorganic material in the polysaccharide membrane, wherein the inorganic material stabilizes the polysaccharide membrane in aqueous solution, and then the separation operation is much more steady. In addition, the selectivity of the polysaccharide membrane may be increased by the characteristics of adsorption or reaction of the inorganic material. Therefore, this present invention does have the economic advantages for industrial applications.

According to the above-mentioned objects, this invention provides a material having cross-linking structures. This material comprises a modified substrate containing polysaccharide and a plurality of bridges formed on the modified substrate. Moreover, the bridges bond to the polysaccharide and are self-bonded, so as to form the cross-linking structures, wherein the bridges are formed by a cross-linking agent. Furthermore, this invention also discloses a method for forming a membrane having cross-linking structures, wherein the method comprises a dissolution process, a mixing process and a membrane fabricating process.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a flowchart of a method of forming a membrane having cross-linking structure, wherein the method is provided in the second preferred embodiment of this invention.

### DESCRIPTION OF THE PREFERRED EMBODIMENTS

What is probed into in the invention is about a material having cross-linking structure and method for forming the same. Detailed descriptions of the production, structure and elements will be provided in the following in order to make the invention thoroughly understood. Obviously, the application of the invention is not confined to specific details familiar to those who are skilled in the cross-linking materials. On the other hand, the common elements and procedures that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

A first preferred embodiment of this invention discloses a polymer solution containing cross-linking agent, and the polymer solution comprises a polysaccharide, a cross-linking agent and an acid solution, wherein the polysaccharide is any one or any combination of the following: guar gum, guar ether, starch, starch ether, xanthan gum, dextran and chitosan. Next, the cross-linking agent having at least one X group and at least one Y group, wherein at least one of said X group is bonded to the polysaccharide, and at least one of said Y group can be hydrolyzed; the general formula of the cross-linking agent is Xₘ-Z-Yₙ, wherein both m and n are integers, m [symbol] 1, n [symbol] 1. Furthermore, the X group can be selected from either the group comprising: 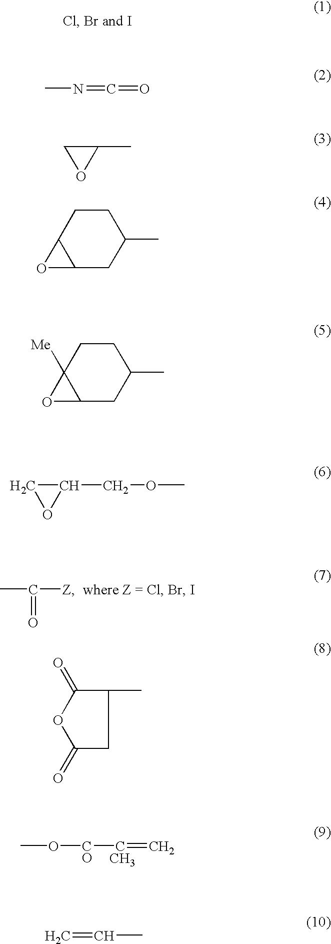
or the group comprising: 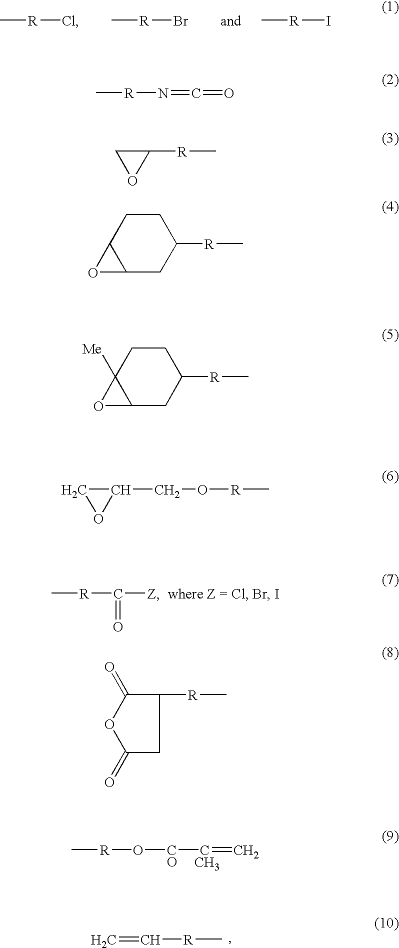
, wherein R is an alkyl group.

In this embodiment, the Y group further comprises alkoxide of 1 to 10 carbon atoms. Moreover, when the Z group is silicon, tin, titanium or zirconium, the cross-linking agent further comprises 3-glycidoxypropyl-trimethoxysilane [symbol] GPTMS [symbol] , and the content of GPTMS is about 0.5 wt % to 70 wt % of the polysaccharide; when the Z group is a group contains nitrogen atoms, the nitrogen atoms-containing group further comprises a structure as follows:

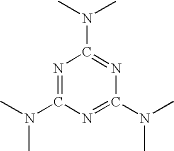

On the other hand, the Z group can bond to at least one alkyl group. Finally, the acid solution dissolves the polysaccharide and catalyzes the hydrolyzed Y groups, so that the hydrolyzed Y groups dehydrate and combine to each other to form cross-linking structure.

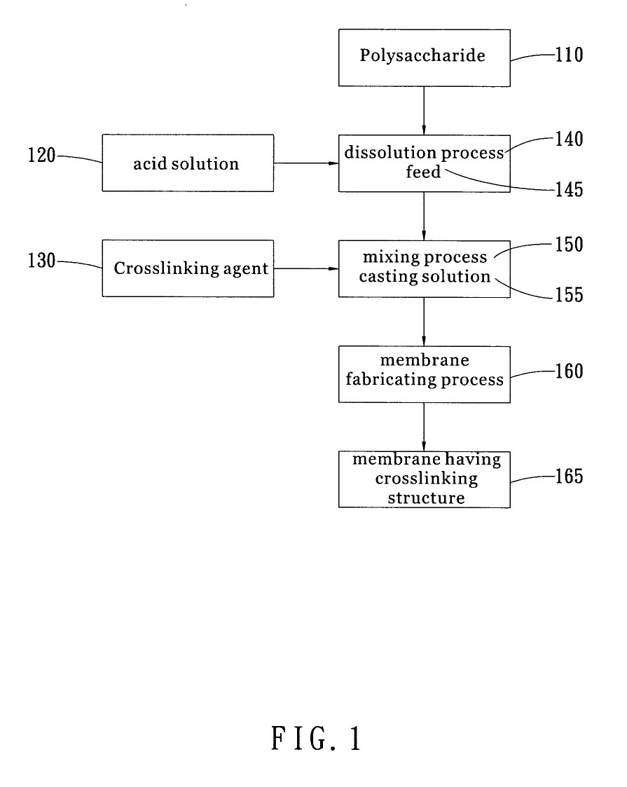

Referring to FIG. 1, in a second preferred embodiment of this invention, a polysaccharide 110 and an acid solution 120 are provided. The polysaccharide 110 is any one or any combination of the following: guar gum, guar ether, starch, starch ether, xanthan gum, dextran and chitosan. Then, the polysaccharide 110 is delivered into a mixing apparatus, and a dissolving process 140 is performed to dissolve the polysaccharide 110 by the acid solution 120 so as to form a feed 145. The feed 145 is subsequently transferred to a separation apparatus and an impurity removing process is performed to remove the impurities from the feed 145, wherein the impurity removing process further comprises a filtration process.

Referring to FIG. 1, in this embodiment, a cross-linking agent 130 is provided, and the cross-linking agent 130 comprises at least one X group and at least one Y group, wherein at least one of said X group is bonded to the polysaccharide 110, and at least one of said Y group is hydrolyzed; the general formula of the cross-linking agent 130 is Xₘ-Z-Yₙ, wherein both m and n are integers, m [symbol] 1, n [symbol] 1. Furthermore, the X group can be selected from either the group comprising: 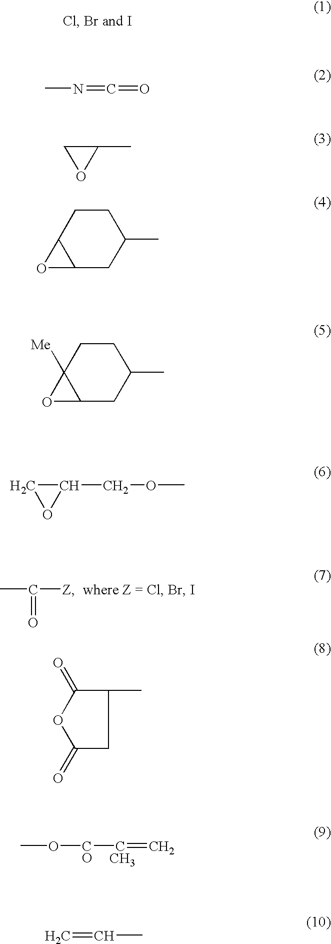
or the group comprising: 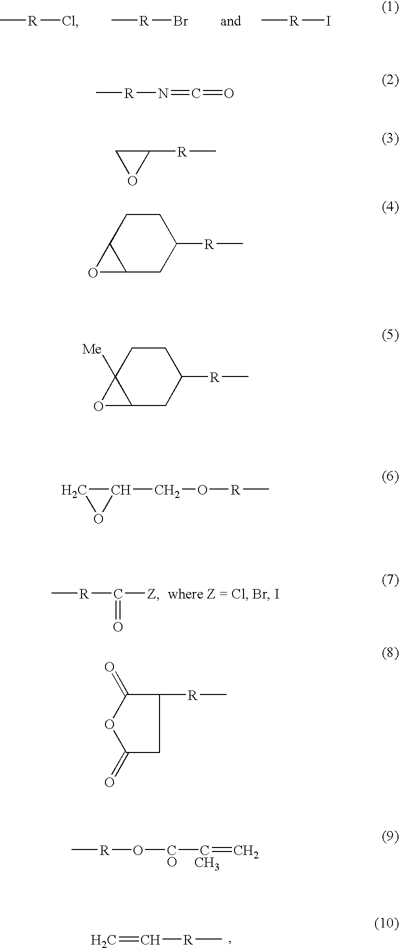
, wherein R is an alkyl group.

In this embodiment, the Y group further comprises alkoxide of 1 to 10 carbon atoms. Moreover, when the Z group is silicon, tin, titanium, or zirconium, the cross-linking agent further comprises 3-glycidoxypropyl-trimethoxysilane [symbol] GPTMS [symbol] , and the content of GPTMS is about 0.5 wt % to 70 wt % of the polysaccharide; when the Z group is a group contains nitrogen atoms, the nitrogen atoms-containing group further comprises a structure as follows:

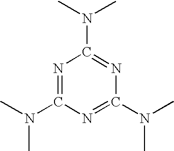

On the other hand, the Z group can bond to at least one alkyl group. Next, the cross-linking agent 130 is delivered to a mixing apparatus, and a mixing process 150 is performed to blend the feed 145 and the cross-linking agent 130, so that at least one X group of the cross-linking agent can bond to a specific functional group of the polysaccharide, and at least one Y group can be hydrolyzed to form a hydroxyl group so as to form a casting solution. Furthermore, the specific functional group of the polysaccharide is amine, hydroxyl or carboxyl. When the polysaccharide 110 is chitosan, at least one X group of the cross-linking agent 130 bonds to the amine group of chitosan. After the mixing process 150, the casting solution 155 and a substrate are transferred to a membrane fabricating apparatus, and a membrane fabricating process 160 is performed for forming a membrane having cross-linking structure 165, wherein the acid in the casting solution 155 catalyzes the hydroxyl groups, so that the hydroxyl groups dehydrate and combine with each other to form cross-linking structure. The membrane fabricating process 160 further comprises a temperature raising process to accelerate the hydrolysis of the Y groups and the dehydrating-combining reaction, so as to form the membrane having cross-linking structure 165. Moreover, the temperature raising process comprises at least one heating step wherein after each heating step, the temperature is remained for a period of time before another heating step is performed. When the polysaccharide 110 is not chitosan, the temperature range of the temperature raising process is 10 [symbol] to 120 [symbol] ; when the polysaccharide 110 is chitosan, the temperature range of the temperature raising process is 10 [symbol] to 170 [symbol] .

In this embodiment, it has been found that chitosan (CS) reacts with GPTMS in the presence of an acid solution according to the following reaction sheme. 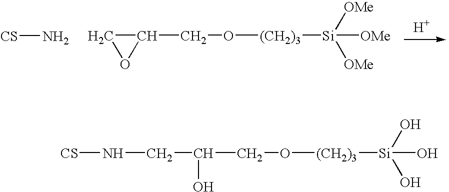
, wherein the hydrolysis of GPTMS in the presence of an acid solution is as following:

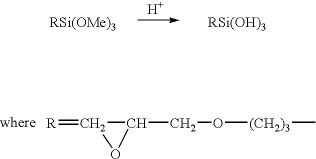

In this embodiment, a fixation process can be performed after the membrane fabricating process. The membrane having cross-linking structure 165 is transported to a fixation apparatus, and a fixation process is performed to neutralize the membrane 165. The fixation process comprises a neutralization process, a cleaning process, and a drying process. The fixation apparatus comprises a neutralization apparatus, a cleaning apparatus, and a drying apparatus. The neutralization process is performed by an alkaline solution for neutralizing the membrane 165 and a by-product of neutralization is formed after the neutralization process. The neutralization process further comprises immersing the membrane 165 into an alkaline solution, wherein the alkaline solution further comprises a sodium hydroxide solution. Subsequently, the by-product of neutralization is removed by performing the cleaning process with a cleaning agent. Finally, a drying process is performed for removing the cleaning agent from the membrane 165, wherein the operating temperature range of the drying process is about 10 [symbol] to 100 [symbol] . The drying apparatus further comprises a baking apparatus or a vacuum apparatus.

Alternatively, an acid-removing process can also be performed after the membrane fabricating process. The membrane having cross-linking structure 165 is transported to an acid-removing apparatus, and an acid-removing process is performed to remove acid from the membrane 165. The acid-removing process comprises a cleaning process and a drying process, and the acid-removing apparatus comprises a cleaning apparatus and a drying apparatus. The acid of the membrane 165 is removed by performing the cleaning process with a cleaning agent. Then, a drying process is performed for removing the cleaning agent from the membrane 165, wherein the operating temperature range of the drying process is about 10 [symbol] to 100 [symbol] . The drying apparatus further comprises a baking apparatus or a vacuum apparatus.

A third preferred embodiment of this invention discloses a material having cross-linking structure, and the material comprises a modified substrate containing chitosan and a plurality of bridges, wherein the bridges are formed on said modified substrate. The bridges bond to the amine group of chitosan, and bond to each other so as to form the cross-linking structure; the bridges are formed by a cross-linking agent having at least one X group and at least one Y group, wherein at least one of said X group is bonded to chitosan, and at least one of said Y group is hydrolyzed, so that the hydrolyzed Y groups combine each other to form the bridges. Particularly, the method for forming the bridges is dehydrating-combining reaction by the cross-linking agent. Next, the general formula of the cross-linking agent is Xₘ-Z-Yₙ, wherein both m and n are integers, m [symbol] 1, n [symbol] 1. Furthermore, the X group can be selected from either the group comprising: 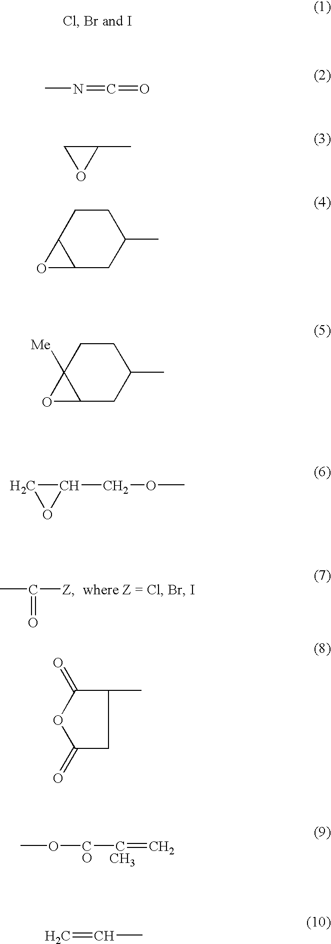
or the group comprising: 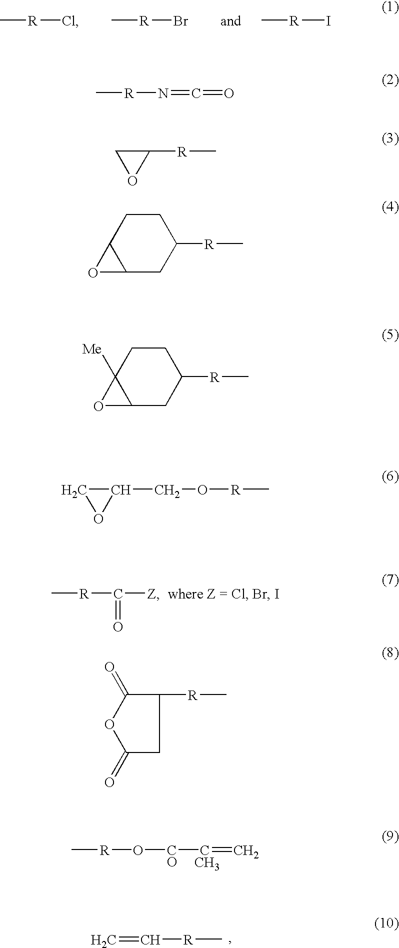
, wherein R is an alkyl group.

In this embodiment, the Y group further comprises alkoxide of 1 to 10 carbon atoms. Moreover, when the Z group is silicon, tin, titanium, or zirconium, the cross-linking agent further comprises 3-glycidoxypropyl-trimethoxysilane [symbol] GPMS [symbol] , and the content of GPTMS is about 0.5 wt % to 70 wt % of the chitosan; when the Z group is a group contains nitrogen atoms, the nitrogen atoms-containing group further comprises a structure as follows:

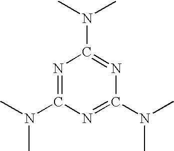

On the other hand, the Z group can bond to at least one alkyl group.

The membranes having cross-linking structure fabricated according to the above-mentioned embodiments are applied in pervaporation process for separating organic solvents, and one result of the pervaporation process is as follows: the membrane of this invention was used to separate an aqueous feed containing 90 wt % of Iso-propyl alcohol [symbol] IPA [symbol] at 70 □. The membrane of this invention shows flux being 342 g/m² per hour and water selectivity being 2991. Moreover, when the aqueous feed containing 70 wt % of Iso-propyl alcohol [symbol] IPA [symbol] at 70 □, the membrane of this invention shows flux being 1811 g/m² per hour and water selectivity being 121. The separation membranes of this invention posses both high flux and high selectivity, and can meet the requirement for industries. Obviously, the performance of this invention is better than that of conventional skills. Further, the membranes of this invention could be applied to other systems for separating organic solvents, such as: alcohol/water and N—N-dimethylformamide (DMF)/water.

According to above-mentioned embodiments, an idea for selecting cross-linking agent with suitable molecular structure is disclosed to adjust the distance between polymer chains in the membrane, so as to form a separation membrane with high selectivity and high flux. Furthermore, part structure of the cross-linking agent may be inorganic. Therefore, the inorganic material is uniformly dispersed in the polysaccharide membrane, wherein the inorganic material stabilizes the polysaccharide membrane in aqueous solution, and then the separation operation is much steadier. In addition, the selectivity of the polysaccharide membrane may be increased by the characteristics of adsorption or reaction of the inorganic material. Accordingly, this present invention does have the economic advantages for industrial applications.

According to the above description, this invention provides a material having cross-linking structures. This material comprises a modified substrate containing polysaccharide and a plurality of bridges formed on the modified substrate. Moreover, the bridges bond to the polysaccharide and are self-bonded, so as to form the cross-linking structures, wherein the bridges are formed by a cross-linking agent. Furthermore, this invention also discloses a method for forming a membrane having cross-linking structures, wherein the method comprises a dissolution process, a mixing process and a membrane fabricating process.

Although only three specific embodiments have been illustrated and described, it will be obvious to those skilled in this art that various modifications may be made without departing from what is intended to be limited solely by the appended claims. Obviously, many modifications and variations of the present invention are possible in light of the above teachings. It is therefore to be understood that within the scope of the appended claims, the present invention may be practiced otherwise than as specifically described herein.

1. A polymer solution containing cross-linking agent, comprising:
a polysaccharide;
a cross-linking agent having at least one X group and at least one Y group, wherein at least one of said at least one X group is bonded to said polysaccharide, and at least one of said at least one Y group is hydrolyzed; the general formula of said cross-linking agent is Xₘ-Z-Yₙ, wherein both m and n are integers, m [symbol] 1, n [symbol] 1 [symbol] and
an acid solution, said acid solution dissolves said polysaccharide and catalyzes the hydrolyzed Y groups, so that the hydrolyzed Y groups dehydrate and combine with each other to form cross-linking structure.

2. The polymer solution according to claim 1, wherein said polysaccharide is ether any one or any combination of the following:
guar gum, guar ether, starch, starch ether, xanthan gum, dextran and chitosan.

3. The polymer solution according to claim 1, wherein at least one said X group further comprises:

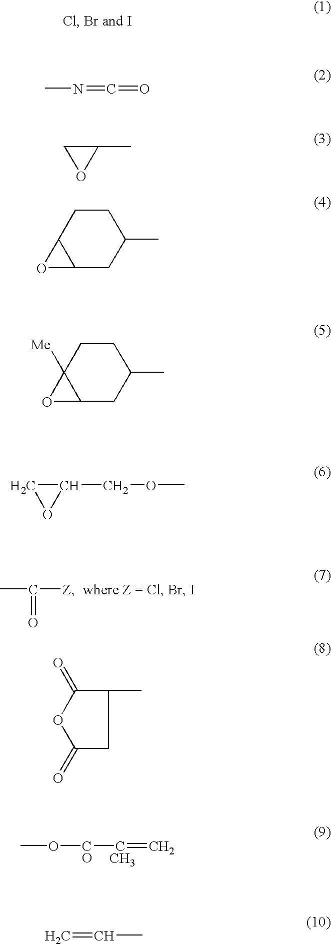

4. The polymer solution according to claim 1, wherein at least one said X group further comprises: 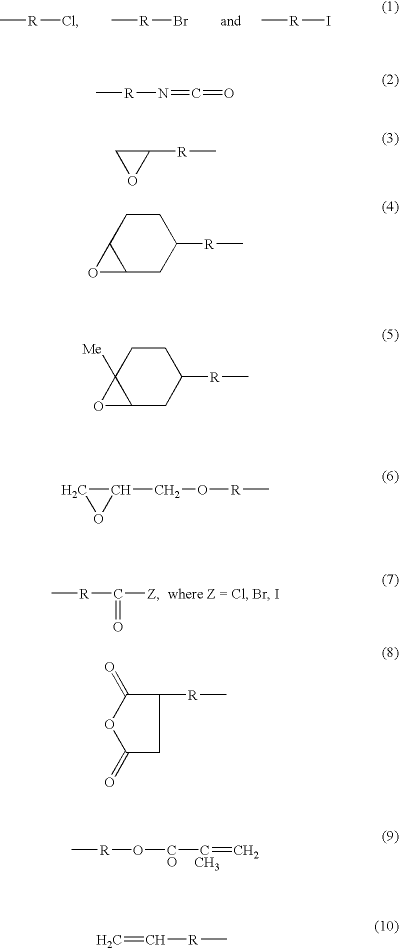
R is an alkyl group.

5. The polymer solution according to claim 1, wherein at least one said Y group comprises alkoxide of 1 to 10 carbon atoms.

6. The polymer solution according to claim 1, wherein said Z group is silicon, tin, titanium, or zirconium.

7. The polymer solution according to claim 6, wherein said cross-linking agent further comprises 3-glycidoxypropyl-trimethoxysilane [symbol] GPTMS [symbol] .

8. The polymer solution according to claim 7, wherein the content of GPTMS is about 0.5 wt % to 70 wt % of said polysaccharide.

9. The polymer solution according to claim 1, wherein said Z group bonds to at least one alkyl group.

10. The polymer solution according to claim 1, wherein said Z group is a group containing nitrogen atoms.

11. The polymer solution according to claim 10, wherein said nitrogen atoms-containing group further comprises a structure as follows:

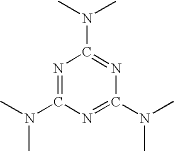

12. A method for forming a membrane having cross-linking structure, comprising:
providing a polysaccharide;
dissolving said polysaccharide by a acid solution for forming a feed;
providing a cross-linking agent having at least one X group and at least one Y group, wherein at least one of said at least one X group is bonded to said polysaccharide, and at least one of said at least one Y group is hydrolyzed; the general formula of said cross-linking agent is Xₘ-Z-Yₙ, wherein both m and n are integers, m [symbol] 1, n [symbol] 1 [symbol] and
mixing said feed and said cross-linking agent to form a casting solution, wherein at least one of said at least one X group of said cross-linking agent is bonded to a specific functional group of said polysaccharide, and at least one of said at least one Y group is hydrolyzed to form a hydroxyl group; and
performing a membrane fabricating process by said casting solution for forming a membrane having cross-linking structure, wherein the acid in said casting solution catalyzes the hydroxyl groups, so that the hydroxyl groups dehydrate and combine with each other to form said cross-linking structure.

13. The method according to claim 12, wherein said polysaccharide is ether any one or any combination of the following:
guar gum, guar ether, starch, starch ether, xanthan gum, dextran, chitosan and their combination.

14. The method according to claim 12, wherein at least one said X group further comprises:

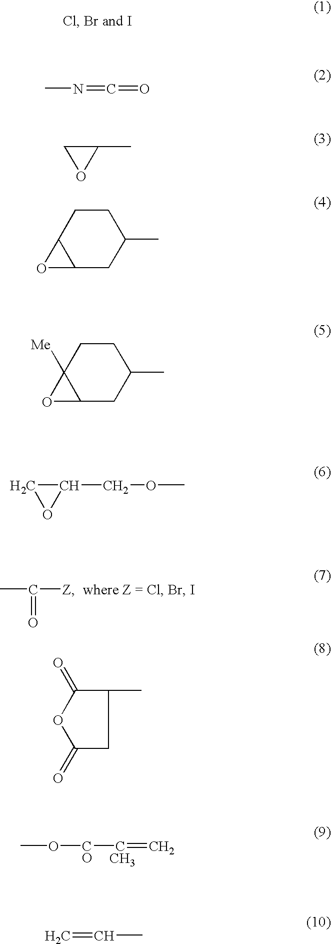

15. The method according to claim 12, wherein at least one said X group further comprises: 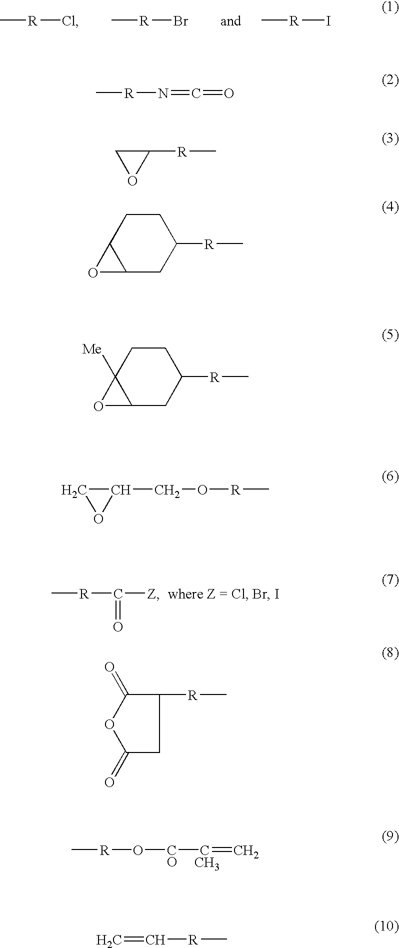
R is an alkyl group.

16. The method according to claim 12, wherein at least one said Y group comprises alkoxide of 1 to 10 carbon atoms.

17. The method according to claim 12, wherein said Z group is silicon, tin, titanium, or zirconium.

18. The method according to claim 17, wherein said cross-linking agent further comprises 3-glycidoxypropyl-trimethoxysilane [symbol] GPTMS [symbol] .

19. The method according to claim 18, wherein the content of GPTMS is about 0.5 wt % to 70 wt % of said polysaccharide.

20. The method according to claim 12, wherein said Z group bonds to at least one alkyl group.

21. The method according to claim 12, wherein said Z group is a group contains nitrogen atoms.

22. The method according to claim 21, wherein said nitrogen atoms-containing group further comprises a structure as follows:

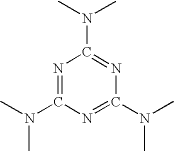

23. The method according to claim 12, wherein said specific functional group is amine, hydroxyl or carboxyl.

24. The method according to claim 12, when said polysaccharide is chitosan, at least one said X group of said cross-linking agent bonds to the amine group of chitosan.

25. The method according to claim 12, wherein said membrane fabricating process further comprises a temperature raising process to accelerate the hydrolysis of the Y groups and the dehydrating-combining reaction, so as to form said membrane having cross-linking structure.

26. The method according to claim 25, wherein said temperature raising process comprises at least one heating step wherein after each heating step, the temperature is remained for a period of time before another heating step is performed.

27. The method according to claim 25, when said polysaccharide is chitosan, the temperature range of said temperature raising process is 10 [symbol] to 170 [symbol] .

28. The method according to claim 12, wherein a fixation process is performed after said membrane fabricating process, and said fixation process comprises:
performing a neutralization process by a alkaline solution for neutralizing said membrane having cross-linking structure and a by-product of neutralization is formed after said neutralization process;
removing said by-product of neutralization by a cleaning agent from said membrane having cross-linking structure; and
performing a drying process for removing said cleaning agent from said membrane having cross-linking structure.

29. The method according to claim 12, wherein an acid-removing process is performed after said membrane fabricating process, and said acid-removing process comprises:
removing the acid by a cleaning agent from said membrane having cross-linking structure; and
performing a drying process for removing said cleaning agent from said membrane having cross-linking structure.

30. A material having cross-linking structure, comprising:
a modified substrate containing chitosan; and
a plurality of bridges formed on said modified substrate, wherein said plurality of bridges bond to the amine group of chitosan, and said plurality of bridges bond to each other so as to form the cross-linking structure; said plurality of bridges are formed by a cross-linking agent having at least one X group and at least one Y group, wherein at least one said X group can bond to chitosan, and at least one said Y group can be hydrolyzed, so that the hydrolyzed Y groups combine each other to form said plurality of bridges; the general formula of said cross-linking agent is Xₘ-Z-Yₙ, wherein both m and n are integers, m [symbol] 1, nz,900 1.

31. The material according to claim 30, wherein the method for forming said plurality of bridges is dehydrating-combining reaction by said cross-linking agent.

32. The material according to claim 30, wherein at least one said X group further comprises:

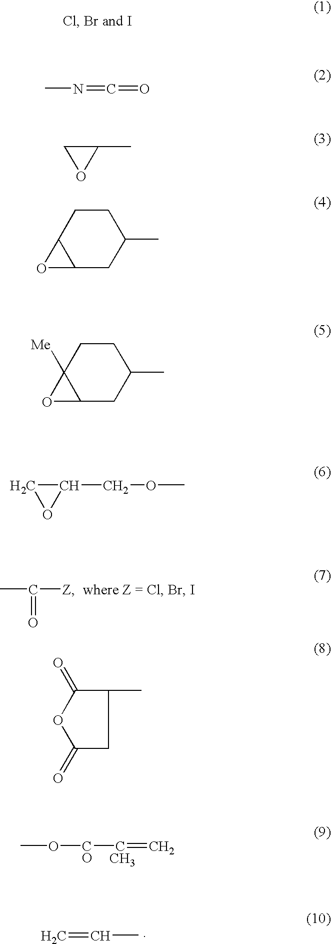

33. The material according to claim 30, wherein at least one said X group further comprises: 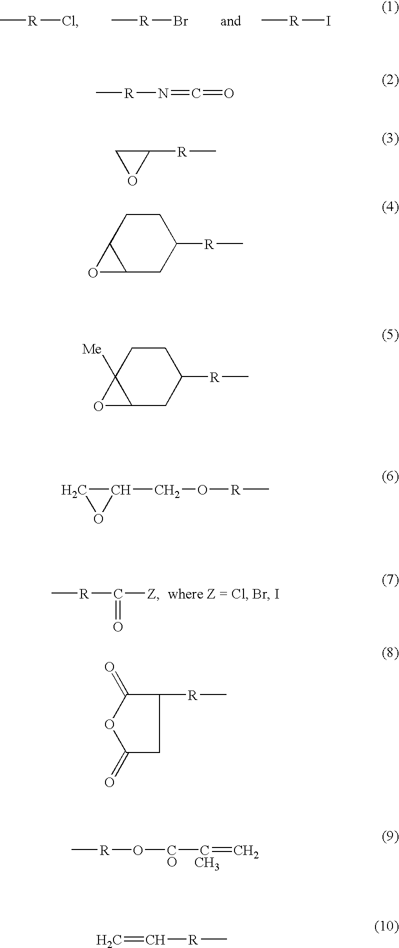
R is an alkyl group.

34. The material according to claim 30, wherein at least one said Y group comprises alkoxide of 1 to 10 carbon atoms.

35. The material according to claim 30, wherein said Z group is silicon, tin, titanium, or zirconium.

36. The material according to claim 35, wherein said cross-linking agent further comprises 3-glycidoxypropyl-trimethoxysilane [symbol] GPTMS [symbol] .

37. The material according to claim 36, wherein the content of GPTMS is about 0.5 wt % to 70 wt % of the chitosan.

38. The material according to claim 30, wherein said Z group bonds to at least one alkyl group.

39. The material according to claim 30, wherein said Z group is a group contains nitrogen atoms.

40. The material according to claim 39, wherein said nitrogen atoms-containing group further comprises a structure as follows: [chemical structure]
